(19) United States
(12) Patent Application Publication
(10) Pub. No.: US 2023/0372191 A1
(43) Pub. Date: Nov. 23, 2023

(54) MASSAGER

(71) Applicant: Guangzhou Pinai Technology Co., Ltd., Guangzhou (CN)

(72) Inventor: Lifu GU, Guangzhou (CN)

(73) Assignee: Guangzhou Pinai Technology Co., Ltd., Guangzhou (CN)

(21) Appl. No.: 17/748,322

(22) Filed: May 19, 2022

(51) Int. Cl. A61H 19/00; A61H 9/00; A61H 23/02

(52) U.S. Cl. CPC A61H 19/32; A61H 9/0078; A61H 23/02; A61H 2201/0173

(57) ABSTRACT

Disclosed is a massager, which includes a massage cylinder and at least two vibrators. The massage cylinder is provided with a massage cavity inside, and one end of the massage cylinder is provided with an insertion port communicated with the massage cavity; and at least two vibrators are protruded from a wall of the massage cavity. The technical solution of the present application can provide a means of physical treatment to help men fight against problems such as reduced sexual function, genital erectile dysfunction.

### TECHNICAL FIELD

The present application relates to the technical field of reproductive medical instruments, in particular to a massager for physical massage treatment of male genitalia.

### BACKGROUND

With the acceleration of the pace of life, the change of living habits and the increase of work pressure, many modern men's bodies are in a sub-health state, and problems such as reduced sexual function, genital erectile dysfunction, etc. are also increasing day by day. At present, the main treatment methods for these problems which are worrying men are oral drug treatment, injection treatment, surgical treatment and so on. Although oral drug treatment and injection treatment are common, but they have some side effects on the human body, and the curative effect is relatively mediocre. Surgical treatment is relatively risky because it belongs to invasive treatment.

### SUMMARY

The main purpose of the present application is to provide a massager, which aims to provide a means of physical treatment to help men fight against problems such as reduced sexual function, genital erectile dysfunction, etc.

The present application provides a massager, comprising:
a massage cylinder provided with a massage cavity inside, and one end of the massage cylinder being provided with an insertion port communicated with the massage cavity; and
at least two vibrators protruded from a wall of the massage cavity.

In an embodiment of the present application, the at least two vibrators are protruded from a side wall of the massage cavity and distributed on both sides of the massage cavity; or, the at least two vibrators are protruded from the side wall of the massage cavity and distributed on a same side of the massage cavity at intervals along a length direction of the massage cylinder.

In an embodiment of the present application, when the two vibrators are distributed on both sides of the massage cavity in a staggered manner along a length direction of the massage cylinder.

In an embodiment of the present application, the massage cylinder comprises:
a housing; and
a lining provided in the housing and provided with the massage cavity, and the insertion port of the massage cavity communicating with an outer space outside the housing, wherein the lining comprises:
a side wall extended along a circumference of the housing to form the massage cavity;
at least two protective covers covered on an inner surface of the side wall; each of the at least two protective covers and the side wall cooperate to form a containing cavity to contain one of the at least two vibrators.

In an embodiment of the present application, a wall of the containing cavity is provided with an assembly opening communicated with an outer surface of the side wall; and/or
the outer surface corresponding to part of the side wall which is covered by the protective cover is provided with a buffer protrusion.

In an embodiment of the present application, the lining is an elastic member, the lining and the housing cooperate to form an inflation cavity, the housing is provided with an inflation passage communicating the outside and the inflation cavity, the inflation passage is provided with an inflation mechanism; the housing is provided with an exhaust passage communicating the outside and the inflation chamber, and an exhaust mechanism is provided in the exhaust passage.

In an embodiment of the present application, the housing is provided with an emergency pressure relief passage communicating the outside and the inflation chamber, and the emergency pressure relief passage is provided with an emergency pressure relief mechanism.

In an embodiment of the present application, wherein the massager further comprises an auxiliary massage sleeve, the auxiliary massage sleeve is of a cylindrical structure with openings at both ends; an end of the auxiliary massage sleeve is provided with a coating opening communicated with an internal space of the auxiliary massage sleeve; an end of the auxiliary massage sleeve away from the coating opening is extended into the massage cavity through the insertion port; the end of the auxiliary massage sleeve provided with the coating opening is protruded outward from the insertion port; and
a plurality of massage protrusions are provided at intervals on an inner side of the auxiliary massage sleeve.

In an embodiment of the present application, the end of the auxiliary massage sleeve away from the coating opening is provided with an avoidance notch, and the at least two vibrators are accommodated in the avoidance notch.

In an embodiment of the present application, the massager further comprises an end cover covering the end of the massage cylinder provided with the insertion port to hide the insertion port; and/or,
the at least two vibrators are vibration motors.

In the present application, when in use, the massage cylinder of the massager can be sleeved on the male genitalia, that is, the male genitalia can enter the massage cavity through the insertion port. In this way, at least two vibrators in the massage cavity can contact at least two positions of the male genitalia. After that, when started, the two vibrators can produce vibration of a certain frequency respectively, and the vibration brings physical massage to at least two positions of the male genitalia. In this way, it can better promote the blood circulation of male genitalia, stimulate the nerve conduction tissue of male genitalia to quickly enhance the excitability, improve the flexibility, strength and length of penis ligament, and delay the aging of penis. In long term use, it can treat problems such as reduced sexual function and genital erectile dysfunction to rehabilitate.

### BRIEF DESCRIPTION OF THE DRAWINGS

In order to more clearly explain the embodiments of the present application or the technical solutions in the prior art, the following will briefly introduce the drawings in the embodiments or the description of the prior art. It is obvious that the drawings in the following description are only some embodiments of the present application. For those skilled in the art, other drawings can be obtained according to the structure shown in these drawings without paying creative labor.

FIG. 1 is a structural view of an embodiment of a massager of the present application.

FIG. 2 is an exploded view of the massager in FIG. 1.

FIG. 3 is an enlarged view of a lining in FIG. 2.

FIG. 4 is an enlarged view of an auxiliary massage sleeve in FIG. 2.

FIG. 5 is a sectional view of the massager in FIG. 1.

FIG. 6 is another sectional view of the massager in FIG. 1.

FIG. 7 is a structural view of another embodiment of the massager of the present application.

The realization of the purpose, functional features and advantages of the present application will be further described with reference to the attached drawings in combination with the embodiments.

### DETAILED DESCRIPTION OF THE EMBODIMENTS

The technical solution in the embodiment of the present application will be clearly and completely described below in combination with the attached drawings in the embodiment of the present application. Obviously, the described embodiments are only a part of the embodiments of the present application, not all of them. Based on the embodiments in the present application, all other embodiments obtained by those skilled in the art without creative work belong to the claimed scope of the present application.

It should be noted that all directional indications (such as up, down, left, right, front, back . . . ) in the embodiment of the present application are only used to explain the relative position relationship and movement among components under a specific attitude (as shown in the attached drawings). If the specific attitude changes, the directional indications will change accordingly.

In addition, in the present application, the description of “first”, “second” and the like is only for descriptive purposes, and cannot be understood as indicating or implying their relative importance or implicitly indicating the number of indicated technical features. Thus, the features defined with “first” and “second” may include at least one of the features explicitly or implicitly. In the description of the present application, “multiple” and “several” mean at least two, such as two, three, etc., unless otherwise expressly and specifically limited.

In the present application, unless otherwise specified and limited, the terms “connection”, “fix” and so on should be understood in a broad sense. For example, “fix” can be a fixed connection, a removable connection or an integration; it can be a mechanical connection or an electrical connection; it can be a direct connection or an indirect connection through an intermediate medium; it can be the connection within two elements or the interaction relationship between two elements, unless otherwise clearly defined. For those skilled in the art, the specific meaning of the above terms in the present application can be understood according to the specific circumstances.

In addition, technical solutions of the embodiments of the present application can be combined with each other, but it must be based on the realization of those skilled in the art. When a combination of technical solutions is contradictory or impossible, it shall be considered that the combination of technical solutions does not exist and is not within the scope of protection required by the present application.

With the acceleration of the pace of life, the change of living habits and the increase of work pressure, many modern men's bodies are in a sub-health state, and problems such as reduced sexual function, genital erectile dysfunction, etc. are also increasing day by day. At present, the main treatment methods for these problems which are worrying men are oral drug treatment, injection treatment, surgical treatment and so on. Although oral drug treatment and injection treatment are common, but they have some side effects on the human body, and the curative effect is relatively mediocre. Surgical treatment is relatively risky because it belongs to invasive treatment.

In view of the above technical problems, the present application proposes a massager, which aims to provide a means of physical treatment to help men to fight against problems such as reduced sexual function, genital erectile dysfunction, etc.

The specific structure of the massager of the present application will be described in the specific embodiment below:

As shown in FIGS. 1 to 5, in an embodiment of the massager 100 of the present application, the massager 100 comprises:
a massage cylinder 10 provided with a massage cavity 10a inside, and one end of the massage cylinder 10 being provided with an insertion port 10b communicated with the massage cavity 10a; and
two vibrators 30 protruded from a side wall of the massage cavity 10a and distributed on both sides of the massage cavity 10a.

It can be understood that in the technical solution of this embodiment, when in use, the massage cylinder 10 of the massager 100 can be provided on the male genitalia, that is, the male genitalia can enter the massage cavity 10a through the insertion port 10b. In this way, two vibrators 30 in the massage chamber 10a can contact both sides of the male genitalia respectively. After that, the two vibrators 30 are started, and each can produce vibration of a certain frequency, and the vibration brings physical massage on both sides of the male genitalia. In this way, it can better promote the blood circulation of the male genitalia, stimulate the nerve conduction tissue of the male genitalia to quickly enhance the excitability, improve the flexibility, strength and length of the penis ligament, and delay the aging of the penis. After a long term use, it can treat problems such as the reduced sexual function and the genital erectile dysfunction, and realize recovery.

Moreover, it can be understood that compared with the physical massage method in the related technology which only relies on the vibration motor in the base to drive the whole massager 100 to vibrate, the technical solution of this embodiment is more conducive to transmit the vibration to the male genitalia, the effect of stimulation and massage are better, and the treatment effect are better for the physical massage method of holding the penis head of the male genitalia with double vibrators 30 is adopted.

It should be noted that the vibrators 30 can adopt electronic devices such as vibration motors which can generate vibration.

Further, in order to improve the treatment effect of the massager 100, in the embodiments shown in FIGS. 1 to 5, positions of the vibrators 30 are also optimized: the two vibrators 30 are provided in a staggered manner along a length direction of the massage cylinder 10.

In this way, the two vibrators 30 in the massage chamber 10a can contact the tubular groove of the penis head of the male genitalia and the prepuce frenum respectively. Then, after being started, the two vibrators 30 can generate vibration of a certain frequency respectively, and the vibration brings physical massage to the tubular groove of the penis head of the male genitalia and to the prepuce frenulum of the penis head of the male genitalia because the nerves in these two places are more densely distributed, such that it can better promote the blood circulation of the male genitalia, stimulate the nerve conduction tissue of the male genitalia to quickly enhance the excitability, improve the flexibility, strength and length of the ligaments of the penis, and delay the aging of the penis. After a long term use, it can treat problems such as the reduced sexual function and the genital erectile dysfunction and realize recovery.

The specific structure of the massage cylinder 10 will be described below.

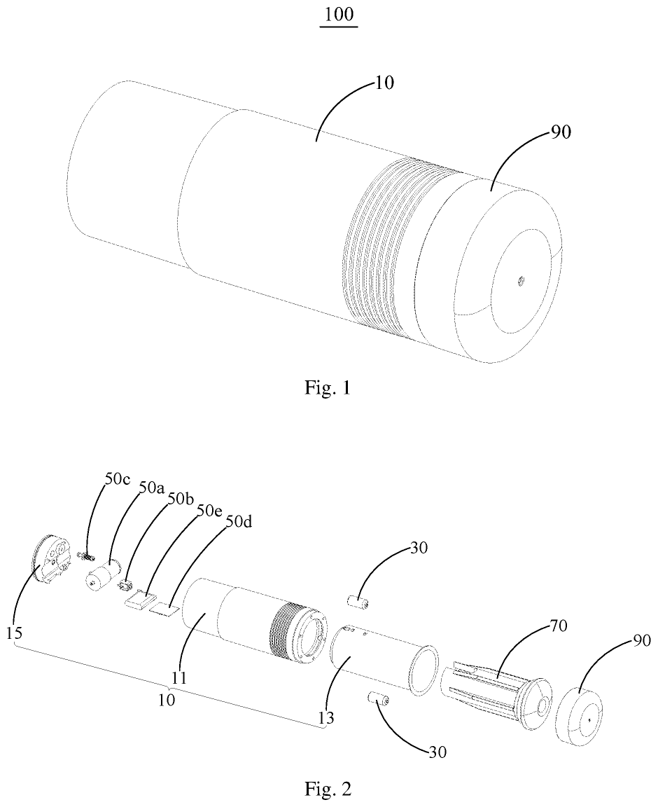

As shown in FIGS. 2 to 4, in an embodiment of the massager 100 of the present application, the massage cylinder 10 comprises:
a housing 11; and
a lining 13 provided in the housing 11 and provided with the massage cavity 10a, and the insertion port 10 of the massage cavity 10a being communicated with an outer space outside the housing 11.

Specifically, the housing 11 is generally made of a plastic material (such as acrylonitrile butadiene styrene plastic) to protect its internal components. The lining 13 is generally made of an elastic material (such as silicone or rubber) to protect the male genitalia and improve the use safety of the massager 100.

In this embodiment, the housing 11 is of cylindrical structure, and an end of the housing 11 is provided with an avoidance opening communicated with an internal space of the housing 11. The lining 13 is of cylindrical structure, and an end of the lining 13 is provided with the insertion port 10b communicated with an internal space thereof (i.e., the massage cavity 10a). The lining 13 extends into the internal space of the housing 11 from the avoidance opening of the housing 11. An end of the lining 13 provided with the insertion port 10b has a flange 135 extending outward. An end of the housing 11 provided with the avoidance opening has a sealing ring, and the flange 135 of the lining 13 is fixed at the end of the housing 11 provided with the avoidance opening by the sealing ring of the housing 11.

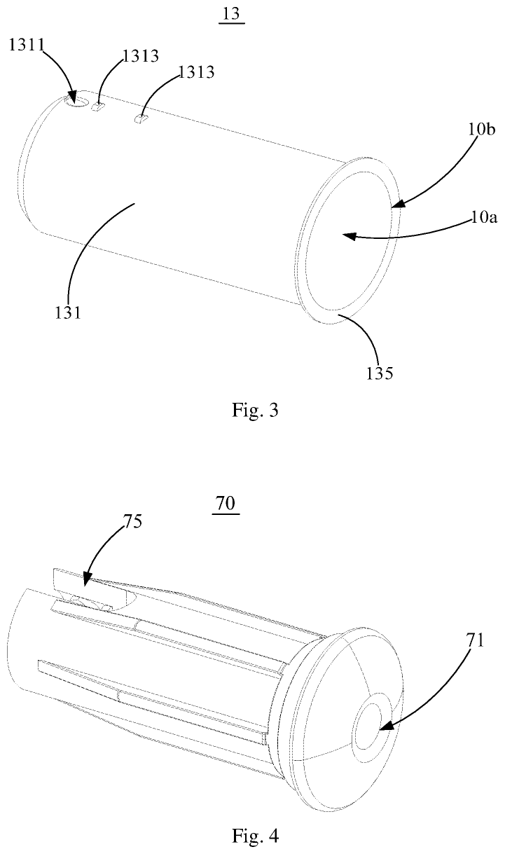

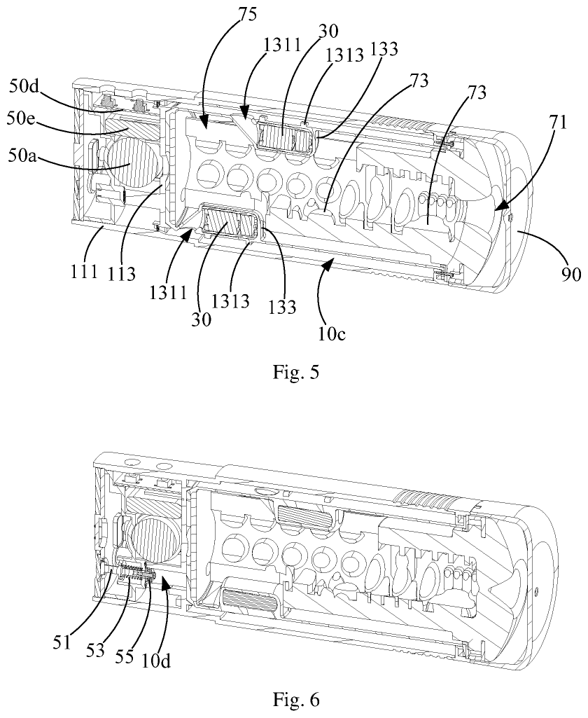

In addition to the above flange 135, as shown in FIG. 3 and FIG. 5, in the embodiment of the massager 100 of the present application, the lining 13 also includes:
a side wall 131 provided along a circumference of the housing 11 to form the massage cavity 10a;
two protective covers 133 covered on an inner surface of the side wall 131, and distributed on both sides of the massage cavity 10a in a staggered manner along an axis direction of the massage cavity 10a; each of the protective covers 133 and the side wall 131 cooperating to form a containing cavity for containing one of the vibrators 30.

It should be understood that the two vibrators 30 can be fixed in the massage chamber 10a by the two protective covers 133. It not only has a simple structure, convenient manufacture, fast assembly, but also has strong stability and high reliability. Moreover, each protective cover 133 is also equivalent to a buffer layer added between the male genitalia and the vibrator 30, which can buffer the vibration of the vibrator 30 to avoid discomfort caused by the direct impact of the vibrator 30 on the male genitalia.

In this embodiment, the two protective covers 133 and the side wall 131 are formed by integrating, such as injection molding, which can improve the integrity of the lining 13 and reduce the number of independent components in the massager 100, so as to simplify the production, manufacturing and assembly process and improve the production efficiency.

Of course, in other embodiments, the two protective covers 133 and the side wall 131 can also be separated from each other, manufactured independently, and then connected and assembled together. For example, the protective cover 133 is connected with the inner surface of the side wall 131 by bonding.

In addition, in order to improve the stability of the vibrator 30, the vibrator 30 can also be encapsulated by filling colloid in the containing cavity.

In addition, it should be noted that in addition to the above embodiment of fixing the vibrators 30 with the protective covers 133, the vibrators 30 can also be fixed on the inner surface of the side wall 131 through intermediate structures such as supports, mesh covers and so on.

Based on the embodiment that the vibrators 30 are contained in the containing cavity, in order to facilitate the assembly of each vibrator 30 in the containing cavity, the following optimization design can also be made for the lining 13, as shown in FIG. 3 and FIG. 5: a cavity wall of the containing cavity is provided with an assembly opening 1311 connected with an outer surface of the side wall 131. That is, the assembly opening 1311 can be provided on the outer surface of the side wall 131 and communicated with the containing cavity to assemble the vibrator 30 into the containing cavity therethrough. At the same time, the elasticity of the lining 13 can also be used to reduce the assembly opening 1311 to prevent the detachment of the vibrator 30. Only when the vibrator 30 needs to be assembled, the assembly opening 1311 is enlarged by the elasticity of the lining 13 to complete the assembly.

Further, in order to reduce the probability that the vibrator 30 collides with the housing 11 and makes abnormal noise when the male genitalia enters the massage chamber 10a, and better protect the vibrator 30, the following optimization design can be made for the lining 13, as shown in FIG. 3 and FIG. 5: the outer surface of part of the side wall 131 covered by the protective cover 133 is provided with a buffer protrusion 1313.

Specifically, two buffer protrusions 1313 are provided on the outer surface corresponding to a position of each vibrator 30, and two buffer protrusions 1313 are provided at intervals along the length direction of the vibrator 30. It can be understood that the buffer protrusions 1313 can be made of silica gel, rubber or other elastic materials.

In this embodiment, each buffer protrusion 1313 and the side wall 131 are formed by integrating, such as injection molding, which can improve the integrity of the lining 13 and reduce the number of independent components in the massager 100, so as to simplify the production, manufacturing and assembly process and improve the production efficiency.

Of course, in other embodiments, each buffer protrusion 1313 and the side wall 131 can also be separated from each other, manufactured independently, and then connected and assembled together. For example, the buffer protrusion 1313 is connected with the outer surface of the side wall 131 by bonding.

As shown in FIG. 2 and FIG. 5, in an embodiment of the massager 100 of the present application, the lining 13 is an elastic member, the lining 13 cooperates with the housing 11 to form an inflation cavity 10c, the housing 11 is provided with an inflation passage communicating the outside with the inflation cavity 10c, and the inflation passage is provided with an inflation mechanism 50a.

In this embodiment, the inflation mechanism 50a is an inflation pump, an air outlet of the inflation pump is communicated with the inflation chamber 10c, and an air inlet of the inflation pump is communicated with the outside. In this way, the outside air can be driven to enter the inflation chamber 10c by the inflation pump. At this time, with an increase of air pressure in the inflation chamber 10c, the elasticity of the lining 13 plays a role, making the whole lining 13 to expand to the center, so as to better squeeze and cover the male genitalia. At this time, combined with the high-frequency vibration emitted by the vibrator 30, the stimulation effect and massage effect on the male genitalia can be further improved, and the effect of physical treatment can be improved.

Further, the housing 11 is also provided with an exhaust passage communicating the outside and the inflation chamber 10c, and the exhaust passage is provided with an exhaust mechanism 50b.

In this embodiment, the exhaust mechanism 50b is an exhaust valve, which is horizontally provided in the exhaust passage. The opening or closing of the exhaust valve can realize the opening or closing of the exhaust passage. It can be understood that when the inflation chamber 10c needs to be inflated, the exhaust valve can be closed, and the communication between the two ends of the exhaust passage can be blocked. The air pressure in the inflation chamber 10c can be maintained until the air pressure in the inflation chamber 10c reaches a set value. When the inflation chamber 10c needs to discharge the air, the exhaust valve can be opened, and the communication between both ends of the exhaust passage is established. The air in the inflation chamber 10c can be released until the air pressure in the inflation chamber 10c returns to an initial value.

It can be understood that with the cooperation of the exhaust mechanism 50b and the inflation mechanism 50a, the cyclic process of inflation and deflation in the inflation chamber 10c can also be realized, so that the lining 13 can be continuously switched between the expansion and the contraction, so that the male genitalia can continuously be extruded, coated and released, so as to realize better physical massage of the male genitalia and improve the treatment effect.

Further, the housing 11 is also provided with an emergency pressure relief passage 10d communicating the outside with the inflation chamber 10c, and the emergency pressure relief passage 10d is provided with an emergency pressure relief mechanism 50c.

In this embodiment, the emergency pressure relief mechanism 50c is a press type conduction mechanism, which is mainly composed of a push rod 51, a spring 53, a sealing plug 55, etc. The push rod 51 is inserted in the emergency pressure relief passage 10d, and an outward end of the push rod 51 is exposed out of the housing 11 for the user to press in an emergency. A sealing step is provided at a cross-section of the emergency pressure relief passage 10d, a step surface of the sealing step is provided towards a side of the inflation chamber 10c, and the sealing plug 55 is abutted against the step surface of the sealing step to block passages on both sides thereof, and the sealing plug 55 is connected with an inward end of the push rod 51. In this way, the push rod 51 is pressed to move inward, the sealing plug 55 can be pushed away from the step surface of the sealing step. At this time, the passages on both sides of the sealing plug 55 is communicated with each other, and the inflation chamber 10c is communicated to the outer space of the housing 11 to realize the emergency pressure relief function. Further, the spring 53 is sleeved on the push rod 51 to drive the pressed push rod 51 to return. Specifically, when the push rod 51 is pressed, the spring 53 is compressed from an initial state. However, after the pressure on the push rod 51 is removed, the spring 53 can return to the initial state and drive the push rod 51 to move outward, and pull the seal plug 55 to contact the step surface of the sealing step again, so that the passages on both sides of the seal plug 55 are blocked. Of course, in other embodiments, the emergency pressure relief mechanism 50c can also be configured as a pull-up conduction mechanism. Those skilled in the art can make a similar configuration for the pull-up conduction mechanism according to the configuration mode of the press type conduction mechanism, which will not be repeated here.

That is, the opening or closing of the emergency pressure relief mechanism 50c can realize the opening or closing of the emergency pressure relief passage 10d. When the inflation chamber 10c needs to be inflated, the emergency pressure relief mechanism 50c is closed and the emergency pressure relief passage 10d is closed. The air pressure in the inflation chamber 10c can be maintained until the air pressure in the inflation chamber 10c reaches the set value. When the air pressure in the inflation chamber 10c is too large and exceeds a critical value, the emergency pressure relief mechanism 50c can be opened to open the emergency pressure relief passage 10d, so that the air in the inflation chamber 10c can be released until the air pressure in the inflation chamber 10c returns to the initial value. In this way, an additional protective barrier can be added for the user in case of failure of the exhaust mechanism 50b. That is, when the pressure in the massage chamber 10a is too high and the electric control mode of the exhaust mechanism 50b fails, the emergency pressure relief mechanism 50c can be manually started to actively start the emergency pressure relief function, so as to improve the use safety of the massager 100.

It should be noted that structurally, the housing 11 includes a cylinder 111 with communicating two ends and a partition plate 113 provided in the cylinder 111. The partition plate 113 divides the space in the cylinder 111 into a first chamber and a second chamber. The lining 13 is assembled in the first chamber, and the lining 13 and the cavity wall of the first chamber cooperate to form the inflation chamber 10c. The inflation mechanism 50a, the exhaust mechanism 50b and the emergency pressure relief mechanism 50c are all provided in the second chamber. The partition plate 113 is provided with two air outlets and one air inlet. The air inlet is communicated with the outside through the inflation passage, and the inflation mechanism 50a is located in the inflation passage. During operation, air is extracted from the outside and output to the inflation chamber 10c on another side of the partition plate 113 through the inflation passage and the air inlet. The two air outlets are respectively communicated with the outside through the exhaust passage and the emergency pressure relief passage 10d, and the exhaust mechanism 50b is located in the exhaust passage. During operation, the inflation chamber 10c is communicated with the outside, so that the air in the inflation chamber 10c can be discharged to the outside through the exhaust passage. The emergency pressure relief mechanism 50c is located in the emergency pressure relief passage 10d. During operation, the inflation chamber 10c is communicated with the outside, so that the air in the inflation chamber 10c can be discharged to the outside through the emergency pressure relief passage 10d.

Moreover, it is understandable that the second chamber can also be configured with an electric control board 50d and a power supply 50e. The electric control board 50d is electrically connected with the power supply 50e. The inflation mechanism 50a and the exhaust mechanism 50b are electrically connected to the electric control board 50d. The power supply 50e supplies power to the electric control board 50d, the inflation mechanism 50a and the exhaust mechanism 50b. The inflation mechanism 50a and the exhaust mechanism 50b are controlled by the electric control board 50d. Further, an end of the second chamber away from the first chamber is covered with a back cover 15 to improve the tightness of the second chamber and protect components therein.

In addition, it should also be noted that the inflation passage, the exhaust passage and the emergency pressure relief passage 10d can be obtained in a variety of ways, and those skilled in the art can reasonably implement the above inflation function, exhaust function and emergency pressure relief function. For example, after one of the air outlets on the partition plate 113 is communicated with the exhaust mechanism 50b, the exhaust mechanism 50b exhausts using the second chamber and the communication opening which is located on the cavity wall of the second chamber and communicated with the outside, that is, the whole second chamber is formed by the partition plate 50b. That is, the exhaust passage at this time is the whole second chamber, which is formed by the housing 11. For another example, in this embodiment, as shown in FIG. 6, another air outlet on the partition plate 113 is connected with the back cover 15 by a pipe, and then the pressure is relieved by the communication opening which is located on the back cover 15 and communicated with the outside, that is, the emergency pressure relief passage 10d at this time is composed of an internal space of the pipe and an internal space of the back cover.

As shown in FIGS. 4 to 6, in an embodiment of the massager 100 of the present application, the massager 100 also includes an auxiliary massage sleeve 70, the auxiliary massage sleeve 70 is of a cylindrical structure with openings at both ends, an end of the auxiliary massage sleeve 70 is provided with a coating opening 71 communicated with an internal space thereof; an end of the auxiliary massage sleeve 70 away from the coating opening 71 extends into the massage cavity 10a through the insertion port 10b; an end of the auxiliary massage sleeve 70 provided with the coating opening 71 is protruded outward from the insertion port 10b;
a plurality of massage protrusions 73 are provided at intervals on an inner side of the auxiliary massage sleeve 70.

At this time, the male genitalia can enter the auxiliary massage sleeve 70 from the coating opening 71 of the auxiliary massage sleeve 70, and the auxiliary massage sleeve 70 can form a better coating of the male genitalia. Moreover, since an inner side of the auxiliary massage sleeve 70 is provided with a plurality of massage protrusions 73 provided at intervals, it can form multi-point contact with the male genitalia, which is helpful to improve the massage effect of the massager 100.

Specifically, the auxiliary massage sleeve 70 is generally made of elastic material (such as thermoplastic elastomer) to protect the male genitalia and improve the use safety of the massager 100.

In a practical application, a length of the auxiliary massage sleeve 70 can be shorter than that of the male genitalia. At this time, the auxiliary massage sleeve 70 only covers the penis body of the male genitalia, and the penis head of the male genitalia passes through the auxiliary massage sleeve 70 and then contacts the two vibrators 30.

Of course, a length of the auxiliary massage sleeve 70 may not be shorter than that of the male genitalia. As shown in FIGS. 4 to 6, in an embodiment of the massager 100 of the present application, an end surface of the auxiliary massage sleeve 70 away from the coating opening 71 is provided with two avoidance notches 75, each of two avoidance notches 75 is located on a side of the auxiliary massage sleeve 70, and each vibrator 30 is accommodated in one of the notches.

At this time, the auxiliary massage sleeve 70 not only coats the penis body of the male genitalia, but also coats the penis head of the male genitalia. The coating effect is better. The auxiliary massage sleeve 70 has more contact points with the male genitalia, and the massage effect is better. In addition, the two vibrators 30 can perform high-frequency vibration massage to the male genitalia within the range of the auxiliary massage sleeve 70. Cooperated with the vibration of the auxiliary massage sleeve 70 caused by the vibrators 30, it can better stimulate and massage the male genitalia, so as to improve the treatment effect.

As shown in FIG. 1, FIG. 2 and FIG. 5, in an embodiment of the massager 100 of the present application, the massager 100 also includes an end cover 90, which covers an end of the massage cylinder 10 provided with the insertion port 10b to hide the insertion port 10b.

It can be understood that the end cover 90 can hide and protect the insertion port 10b. When there is an auxiliary massage sleeve 70, it can also hide and protect the end of the auxiliary massage sleeve 70 provided with the coating opening 71. In this way, on the one hand, it reduces the possibility of invasion and pollution of external pollutants to the massage chamber 10a and the auxiliary massage sleeve 70, improves the cleanliness of the massager 100, and reduces the risk of infringement on the user's health; on the other hand, the lining 13 and the auxiliary massage sleeve 70 can be prevented from being damaged, so as to ensure the durability and effectiveness of the massager 100.

Specifically, the end cover 90 can be fixed to the housing 11 by a threaded connection, a snap connection, or another reasonable and effective connection., which will not be repeated here.

Of course, in addition to the above embodiments, the massager 100 of the present application can also be implemented in the following ways.

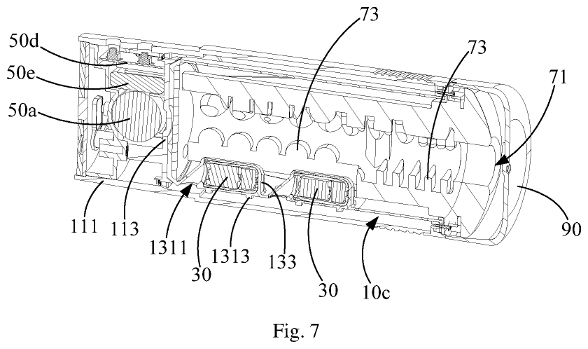

As shown in FIG. 7, in an embodiment of the massager 100 of the present application, the massager 100 comprises:
a massage cylinder 10 provided inside with a massage cavity 10a, and an end of the massage cylinder 10 being provided with an insertion port 10b communicated with the massage cavity 10a; and
two vibrators 30 protruded from a side wall of the massage cavity 10a, and located on a same side of the massage cavity 10a and provided at intervals along a length direction of the massage cylinder 10.

It can be understood that in the technical solution of this embodiment, when in use, the massage cylinder 10 of the massager 100 can be provided on the male genitalia, that is, the male genitalia can enter the massage cavity 10a through the insertion port 10b. In this way, two vibrators 30 in the massage chamber 10a can contact different positions on a same side of the male genitalia. After that, after being started, the two vibrators can produce vibration of a certain frequency respectively, and the vibration brings physical massage to different positions on a same side of the male genitalia. In this way, it can better promote the blood circulation of male genitalia, stimulate the nerve conduction tissue of male genitalia to quickly enhance the excitability, improve the flexibility, strength and length of the penis ligament, and delay the aging of the penis. After long term use, it can treat problems such as reduced sexual function and genital erectile dysfunction, and realize recovery.

In addition, it should also be noted that, in addition to the above embodiment of configuring two vibrators 30 on the side wall of the massage cavity 10a, more vibrators 30 can be configured on a bottom wall and/or a side wall of the massage cavity 10a to realize the physical massage to other positions of the male genitalia and improve the treatment effect of the massager 100. That is, the massager 100 includes at least two vibrators 30 protruding from the wall of the massage cavity 10a.

It should be understood that in such a configuration, when in use, the massage cylinder 10 of the massager 100 can be sleeved on the male genitalia, that is, the male genitalia can enter the massage cavity 10a through the insertion port 10b. In this way, at least two vibrators 30 in the massage cavity 10a can contact at least two positions of the male genitalia. After that, after being started, the two vibrators 30 can generate vibration of a certain frequency respectively, and the vibration brings physical massage to at least two positions of the male genitalia. In this way, it can better promote the blood circulation of male genitalia, stimulate the nerve conduction tissue of male genitalia to quickly enhance the excitability, improve the flexibility, strength and length of the penis ligament, and delay the aging of the penis. After long term use, it can treat problems such as reduced sexual function and genital erectile dysfunction to rehabilitate.

The above is only the preferred embodiment of the present application and does not limit the scope of the patent of the present application. Under the inventive concept of the present application, any equivalent structural transformation made by using the contents of the description and drawings of the present application, or any direct/indirect application in other relevant technical fields, is included in the claimed scope of the present application.

1. A massager, comprising:
a massage cylinder provided with a massage cavity inside, and one end of the massage cylinder being provided with an insertion port communicated with the massage cavity; and
at least two vibrators protruded from a wall of the massage cavity.

2. The massager according to claim 1, wherein,
the at least two vibrators are protruded from a side wall of the massage cavity and distributed on both sides of the massage cavity; or
the at least two vibrators are protruded from the side wall of the massage cavity and distributed on a same side of the massage cavity at intervals along a length direction of the massage cylinder.

3. The massager according to claim 2, wherein when the two vibrators are distributed on both sides of the massage cavity in a staggered manner along a length direction of the massage cylinder.

4. The massager according to claim 1, wherein the massage cylinder comprises:
a housing; and
a lining provided in the housing and provided with the massage cavity, and the insertion port of the massage cavity communicating with an outer space outside the housing, wherein the lining comprises:
a side wall extended along a circumference of the housing to form the massage cavity; and
at least two protective covers covered on an inner surface of the side wall; each of the at least two protective covers and the side wall cooperating to form a containing cavity to contain one of the at least two vibrators.

5. The massager according to claim 4, wherein a wall of the containing cavity is provided with an assembly opening communicated with an outer surface of the side wall; and/or
the outer surface corresponding to part of the side wall which is covered by the protective cover is provided with a buffer protrusion.

6. The massager according to claim 4, wherein the lining is an elastic member, the lining and the housing cooperate to form an inflation cavity, the housing is provided with an inflation passage communicating the outside and the inflation cavity, the inflation passage is provided with an inflation mechanism; the housing is provided with an exhaust passage communicating the outside and the inflation chamber, and an exhaust mechanism is provided in the exhaust passage.

7. The massager according to claim 6, wherein the housing is provided with an emergency pressure relief passage communicating the outside and the inflation chamber, and the emergency pressure relief passage is provided with an emergency pressure relief mechanism.

8. The massager according to claim 1, wherein the massager further comprises an auxiliary massage sleeve, the auxiliary massage sleeve is of a cylindrical structure with openings at both ends; an end of the auxiliary massage sleeve is provided with a coating opening communicated with an internal space of the auxiliary massage sleeve; an end of the auxiliary massage sleeve away from the coating opening is extended into the massage cavity through the insertion port; the end of the auxiliary massage sleeve provided with the coating opening is protruded outward from the insertion port; and
a plurality of massage protrusions are provided at intervals on an inner side of the auxiliary massage sleeve.

9. The massager according to claim 8, wherein the end of the auxiliary massage sleeve away from the coating opening is provided with an avoidance notch, and the at least two vibrators are accommodated in the avoidance notch.

10. The massager according to claim 1, wherein the massager further comprises an end cover covering the end of the massage cylinder provided with the insertion port to hide the insertion port; and/or
the at least two vibrators are vibration motors.

11. The massager according to claim 2, wherein the massager further comprises an end cover covering the end of the massage cylinder provided with the insertion port to hide the insertion port; and/or
the at least two vibrators are vibration motors.

12. The massager according to claim 3, wherein the massager further comprises an end cover covering the end of the massage cylinder provided with the insertion port to hide the insertion port; and/or
the at least two vibrators are vibration motors.

13. The massager according to claim 4, wherein the massager further comprises an end cover covering the end of the massage cylinder provided with the insertion port to hide the insertion port; and/or
the at least two vibrators are vibration motors.

14. The massager according to claim 5, wherein the massager further comprises an end cover covering the end of the massage cylinder provided with the insertion port to hide the insertion port; and/or
the at least two vibrators are vibration motors.

15. The massager according to claim 6, wherein the massager further comprises an end cover covering the end of the massage cylinder provided with the insertion port to hide the insertion port; and/or
the at least two vibrators are vibration motors.

16. The massager according to claim 2, wherein the massager further comprises an auxiliary massage sleeve, the auxiliary massage sleeve is of a cylindrical structure with openings at both ends; an end of the auxiliary massage sleeve is provided with a coating opening communicated with an internal space of the auxiliary massage sleeve; an end of the auxiliary massage sleeve away from the coating opening is extended into the massage cavity through the insertion port; the end of the auxiliary massage sleeve provided with the coating opening is protruded outward from the insertion port; and
a plurality of massage protrusions are provided at intervals on an inner side of the auxiliary massage sleeve.

17. The massager according to claim 3, wherein the massager further comprises an auxiliary massage sleeve, the auxiliary massage sleeve is of a cylindrical structure with openings at both ends; an end of the auxiliary massage sleeve is provided with a coating opening communicated with an internal space of the auxiliary massage sleeve; an end of the auxiliary massage sleeve away from the coating opening is extended into the massage cavity through the insertion port; the end of the auxiliary massage sleeve provided with the coating opening is protruded outward from the insertion port; and
a plurality of massage protrusions are provided at intervals on an inner side of the auxiliary massage sleeve.

18. The massager according to claim 4, wherein the massager further comprises an auxiliary massage sleeve, the auxiliary massage sleeve is of a cylindrical structure with openings at both ends; an end of the auxiliary massage sleeve is provided with a coating opening communicated with an internal space of the auxiliary massage sleeve; an end of the auxiliary massage sleeve away from the coating opening is extended into the massage cavity through the insertion port; the end of the auxiliary massage sleeve provided with the coating opening is protruded outward from the insertion port; and
a plurality of massage protrusions are provided at intervals on an inner side of the auxiliary massage sleeve.

19. The massager according to claim 5, wherein the massager further comprises an auxiliary massage sleeve, the auxiliary massage sleeve is of a cylindrical structure with openings at both ends; an end of the auxiliary massage sleeve is provided with a coating opening communicated with an internal space of the auxiliary massage sleeve; an end of the auxiliary massage sleeve away from the coating opening is extended into the massage cavity through the insertion port; the end of the auxiliary massage sleeve provided with the coating opening is protruded outward from the insertion port; and
a plurality of massage protrusions are provided at intervals on an inner side of the auxiliary massage sleeve.

20. The massager according to claim 6, wherein the massager further comprises an auxiliary massage sleeve, the auxiliary massage sleeve is of a cylindrical structure with openings at both ends; an end of the auxiliary massage sleeve is provided with a coating opening communicated with an internal space of the auxiliary massage sleeve; an end of the auxiliary massage sleeve away from the coating opening is extended into the massage cavity through the insertion port; the end of the auxiliary massage sleeve provided with the coating opening is protruded outward from the insertion port; and
a plurality of massage protrusions are provided at intervals on an inner side of the auxiliary massage sleeve.
